(19) United States
(12) Patent Application Publication
(10) Pub. No.: US 2013/0018116 A1
(43) Pub. Date: Jan. 17, 2013

(54) RESIN FOAM SHEET, AND METHOD FOR PRODUCING RESIN FOAM SHEET

(71) Applicants: Tadakazu Anan, Nara (JP); Toshiyuki Oonishi, Nara (JP)

(72) Inventors: Tadakazu Anan, Nara (JP); Toshiyuki Oonishi, Nara (JP)

(73) Assignee: SEKISUI PLASTICS CO., LTD., Osaka (JP)

(21) Appl. No.: 13/637,102

(22) PCT Filed: Feb. 25, 2011
(86) PCT No.: PCT/JP2011/054290

§ 371 Date: Sep. 25, 2012

(30) Foreign Application Priority Data
Mar. 29, 2010 (JP) 2010-075326

(51) Int. Cl. C08L 23/12; C08J 9/14

(52) U.S. Cl. 521/93; 521/134

(57) ABSTRACT

An object is to provide a resin foam sheet having good reformability, and a method for easily producing such a resin foam sheet. Provided are a resin foam sheet formed by extrusion foaming with an extruder a polypropylene-based resin composition mainly composed of a polypropylene-based resin component containing a polypropylene-based resin and a high melt tension polypropylene resin having a higher melt tension than that of the polypropylene-based resin, wherein the high melt tension polypropylene resin has a melt tension after being passed through the extruder of 4 cN or more and 10 cN or less, and a rate at breakage after being passed through the extruder of 12 m/min or higher and 26 m/min or lower, and the like.

### TECHNICAL FIELD

The present invention relates to a resin foam sheet, and a method for producing a resin foam sheet, and particularly to a resin foam sheet formed by extrusion foaming with an extruder a polypropylene-based resin composition mainly composed of a polypropylene-based resin component containing a high melt tension polypropylene resin, and a method for producing a resin foam sheet for producing such a resin foam sheet.

### BACKGROUND ART

Conventionally when molded products are formed using a resin composition mainly composed of a polypropylene-based resin component, a polypropylene-based resin called a high melt tension polypropylene resin (HMS-PP) is sometimes used for modification.

The HMS-PP is a polypropylene-based block copolymer containing olefin blocks introduced thereto, and a polypropylene-based resin having been subjected to partial cross-linking by an active energy ray such as radiation or electron beams or partial cross-linking by chemical cross-linking and exhibiting, for example, a melt tension at 230° C. of as high a value as 5 cN or more; and addition of the HMS-PP to a starting material in the case of producing a resin foam sheet is known to exhibit an effect of micronizing gas bubbles.

Such a resin foam sheet is broadly used as a starting material for products such as food trays; when food trays are formed, reforming using a sheet forming method is sometimes carried out.

There remains room for improvement in a resin foam sheet from the viewpoint of formability in such reforming.

For example, the following Patent Document 1 carries out studies on materials suitable for production of a foam sheet excellent in surface smoothness.

However, many of such efforts pay attention to the blend ratio of a plurality of resin materials, and the like, and there are relatively few studies conducted by paying attention to melt characteristics of a resin having close connection to foaming behavior of a resin.

Generally in a resin foam sheet, since the strength is likely to decrease as the open cell ratio increases, formation of fine closed cells by blending a high melt tension polypropylene resin or otherwise can be effective means for improving the strength.

On the other hand, since the addition of a high melt tension polypropylene resin results in impartation of a high melt tension to the obtained resin foam sheet, there arises a risk of decreasing the formability when a reformed product using the resin foam sheet is produced, in some cases:

### PRIOR ART DOCUMENTS

### Patent Document

Patent Document 1: Japanese Patent Laid-Open No. 2006-257307

### DISCLOSURE OF THE INVENTION

### Problems to be Solved by the Invention

The present invention has been made to provide a resin foam sheet having good reformability, and a production method capable of easily producing such a resin foam sheet, by paying attention to melt characteristics of a resin, which have not been conventionally so much paid attention to.

### Means for Solving Problems

As a result of intensive studies to solve the above-mentioned problem, the present inventors have found that the use of a polypropylene-based resin having a predetermined relationship between the melt tension and the rate at breakage thereof after being extrusion foamed with an extruder can easily produce a resin foam sheet excellent in formability in reforming, and this finding has led to the completion of the present invention.

That is, according to the present invention, there is provided a resin foam sheet, which is formed by extrusion foaming with an extruder a polypropylene-based resin composition mainly composed of a polypropylene-based resin component containing a high melt tension polypropylene resin, wherein the high melt tension polypropylene resin has a melt tension after being passed through the extruder of 4 cN or more and 10 cN or less, and a rate at breakage after being passed through the extruder of 12 m/min or higher and 26 m/min or lower.

Further, according to the present invention, there is provided a method for producing a resin foam sheet, including extrusion forming with an extruder a polypropylene-based resin composition mainly composed of a polypropylene-based resin component containing a high melt tension polypropylene resin, to thereby produce the resin foam sheet, wherein as the high melt tension polypropylene resin the method uses a high melt tension polypropylene resin having a melt tension after being passed through the extruder of 4 cN or more and 10 cN or less, and a rate at breakage after being passed through the extruder of 12 m/min or higher and 26 m/min or lower.

The “melt tension and rate at breakage after being passed through an extruder” can be determined, for example, by extruding a strand-shape measurement sample (HMS-PP) using a “Labo Plastomill (a main body (model: 4M150) installed with a twin screw extruder (model: 2D15W, diameter: 15 mm, L/D: 17) and a mold having a circular opening of 3 mm in diameter)”, manufactured by Toyo Seiki Seisaku-sho, Ltd., setting the temperature of the entire zone of the twin screw extruder at 220° C. and fixing the rotation frequency of the screw at 60 rpm; and successively by making the strand-shape sample pass through a water tank of 1 m containing water at 20° C. to cool the sample, and thereafter cutting the sample into rod-shape pellets of 4 mm in length by a cutter, and measuring the melt tension and the rate at breakage of the cut sample.

The “melt tension and rate at breakage” can be measured using a twin-bore capillary rheometer, and can specifically be measured as follows.

A polypropylene-based resin (HMS-PP) to be the sample is placed in a cylinder of 15 mm in inner diameter disposed vertically and heated at a temperature of 230° C. for 5 min to be melted; then, a piston is inserted from the top of the cylinder, and the molten resin is extruded in a string-like shape from a capillary (the die diameter: 2.095 mm, the die length: 8 mm; the inflow angle: 90 degrees (conical)) equipped at the lower end of the cylinder so as for the extrusion rate to be 0.0773 mm/s (constant); and the string-like object is passed over a tension detecting pulley disposed below the capillary, and then taken up on a take-up roll.

The initial take-up rate at this time is set at 4 mm/s, and then the take-up rate is gradually increased with an acceleration of 12 mm/s²; and the take-up rate at the time of steep decrease of the tension observed with the tension detecting pulley is measured as the “rate at breakage”, and the maximum tension found over the period of time until the observation of the “rate at breakage” is measured as the “melt tension”.

### Advantages of the Invention

Since the present invention uses a high melt tension polypropylene resin having a predetermined relationship between the melt tension and the rate at breakage thereof after being passed through an extruder, as a material for forming a resin foam sheet, the present invention can easily produce a resin foam sheet excellent in formability in reforming.

### DESCRIPTION OF EMBODIMENTS

Hereinafter, an embodiment according to the present invention will be described by way of one example of a resin foam sheet.

The resin foam sheet (hereinafter, simply referred to also as “foam sheet”) according to the present embodiment is a resin foam sheet formed by extrusion foaming with an extruder a polypropylene-based resin composition mainly composed of a polypropylene-based resin component containing a high melt tension polypropylene resin.

In the high melt tension polypropylene resin contained in the polypropylene-based resin component, it is important that the melt tension (T: cN) and the rate at breakage (V: m/min) satisfy the following condition (1) in the state of the high melt tension polypropylene resin after being passed through an extruder as described above.

(4≦T≦10) and (12≦V≦26) Condition (1)

By the way, application of shearing in a molten state to a polypropylene-based resin by an extruder or the like generally causes changes of a decrease in the value of the “melt tension” and a rise in the value of the “rate at breakage” with respect to the state of a fresh material before being introduced to an extruder, that is, a material called a “virgin material”.

For example, if a virgin material has a melt tension exceeding 10 cN and a rate at breakage of lower than 12 m/min, the virgin material makes the state satisfying the above-mentioned condition (1) after being passed through an extruder, at a relatively high probability.

However, since a virgin material having an excessively high melt tension gives an excessively viscous molten resin, and there arises a risk that extrusion foaming itself cannot be carried out, the virgin material preferably has a melt tension of 30 cN or less in the initial state.

From these facts, the melt tension of a virgin material is preferably 15 cN or more and 25 cN or less, and more preferably 17 cN or more and 23 cN or less.

The rate at breakage of a virgin material is preferably 2.0 m/min or higher and 5.0 m/min or lower, and more preferably 2.4 m/min or higher and 3.0 m/min or lower.

Such a high melt tension polypropylene resin (HMS-PP) which can be adopted as a starting material of the resin foam sheet according to the present embodiment is selected from ones commercially available as, for example, trade names “WB135HMS” and “WB140HMS”, by Borealis AG, and trade name “Pro-fax F814”, by LyondellBasell Industries, and other commercially available products.

On the selection, the extrusion test by a “Labo Plastomill” described above and the measurement by a “capillary rheometer” described above may be carried out.

Among polypropylene-based resins imparted with a high melt tension by forming a free-terminal long chain branching in the molecule thereof, a polypropylene-based resin satisfying the above-mentioned condition (1) can easily be found by carrying out the measurements of the “melt tension” and the “rate at breakage” after the polypropylene-based resins are passed through an extruder.

Such a polypropylene-based resin having a long chain branching includes one in which the free-terminal long chain branching is formed by partial cross-linking by irradiation of an active energy ray such as an electron beam or a radiation, and one in which the free-terminal long chain branching is formed by chemical cross-linking.

In the case of adopting commercially available products, since the products of even the same grade but of different production lots give different results in some cases, the above-mentioned measurement is preferably carried out for each lot of the product to check whether or not the lot satisfies the above-mentioned condition (1).

Generally since HMS-PP has an excessively high melt tension as a single substance and is more expensive than common polypropylene-based resins, the HMS-PP is used as a mixture with other polypropylene-based resins.

That is, use of HMS-PP as a mixture with a common polypropylene-based resin such as a polypropylene-based resin (block PP) which has an olefin block and a polypropylene block, and exhibits a slightly high melt tension, or a homopolypropylene-based resin (homoPP) is preferable from the viewpoint of the material cost of a foam sheet, and the like.

A polypropylene-based resin composition may contain, in addition to a polypropylene-based resin, a resin having a high compatibility with the polypropylene-based resin, such as a polyethylene (PE), an ethylene-ethyl acrylate copolymer resin, an ethylene-vinyl acetate copolymer resin, a polybutene resin or a poly-4-methylpentene-1 resin, as a polymer component other than a polypropylene-based resin component.

However, the excessive introduction of such other components brings about risks of making difficult the impartation of desired flow characteristics and foaming characteristics in extrusion foaming, and making difficult the impartation of desired physical properties to foam sheets or reformed products.

Therefore, the total amount of all the polypropylene-based resins including the HMS-PP is preferably 80% by mass or more, and especially preferably 90% by mass or more, in the whole polymer component of a polypropylene-based resin composition used for formation of a foam sheet.

The case where the amount of HMS-PP added is a minute one has a risk of making it difficult for a foam sheet excellent in strength and beautiful in appearance to be obtained.

Therefore, the content of HMS-PP having a melt tension after being passed through an extruder of 4 cN or more and 10 cN or less is preferably 25% by mass or more, and more preferably 30% by mass or more, in the whole polymer component of the HMS-PP.

However, even if the blend amount is increased excessively, a more effect can hardly be attained while the material cost increases.

Additionally, it has a risk of causing continuous stripe patterns in the extrusion direction on a foam sheet.

Describing this in detail, that HMS-PP imparts a tension to a molten resin has an effect of stabilizing cells when a polypropylene-based resin composition is extrusion foamed from, for example, a circular die, and easily provides a foam sheet having a finely foaming state, while exhibiting an action to cause sharp foaming right after extrusion, resulting in a risk of causing variations in thickness in the foam sheet.

For example, when a polypropylene-based resin composition containing a foaming agent is extrusion foamed as a cylindrical foam body from a circular die, an increase in the thickness is caused along with an increase in the foaming degree, resulting in causing an apparent volume expansion, but the foam body undergoes volume expansion not only in the thickness direction, but also in the circumferential direction.

A foam sheet is generally produced by a method in which a mandrel having a larger diameter than that of a circular die is disposed on the downstream side of the circular die, and the foam body is expanded in diameter by the circular die, and the diameter-expanded foam body is taken up by a take-up machine disposed on a further downstream side of the circular die; however, if the foaming in the circumferential direction occurs excessively, loose portions are formed on the foam body in the vicinity of the outlet of the circular die.

That is, the foam body gets a wavy state in the circumferential direction and variations in the cooling condition and the applied tension are caused, resulting in formation of stripe patterns continuing in the extrusion direction on a foam sheet.

If stripes are caused in such a way, since not only a problem with the appearance but a variation in the strength are easily caused, when sheet forming or the like is carried out using the foam sheet, there arises a risk of causing local elongation shortage and wrinkle or other defects.

Therefore, it is preferable that by setting an upper limit in the content of HMS-PP, the foaming behavior is made mild or moderate and the volume expansion of a foam body right after extrusion from a circular die is made gentle.

That is, the content of HMS-PP having a melt tension after being passed through an extruder of 4 cN or more and 10 cN or less is made to be preferably less than 50% by mass, and especially preferably 45% by mass or less in the whole polymer component, in the point of being capable of suppressing stripes.

It is important that the melt tension of the HMS-PP after being passed through an extruder is 4 cN or more and 10 cN or less in reforming of a foam sheet; this is because the case where the melt tension is less than 4 cN means making a state of easily causing foam breaking in foaming molding, and means giving a high open cell ratio, leading to being liable to cause molding defects including, for example, not providing a sufficient secondary expansion ratio.

From such a viewpoint, a foam sheet is produced so that the open cell ratio thereof is preferably lower than 13%, and especially preferably lower than 10%.

On the other hand, with respect to the upper limit of the melt tension, the case where the melt tension exceeds 10 cN means an excessively high tension of a molten resin when a foam sheet is formed, providing a risk of causing appearance defects such as irregularities on the sheet surface.

Setting of the rate at breakage of HMS-PP after being passed through an extruder in the above-mentioned range in the above-mentioned condition (1) is because the case where the rate at breakage is lower than 12 m/min means an insufficient elongation of a foam sheet, providing a risk of being liable to cause molding defects including, for example, “wrinkles” and “tears” when a tray or the like whose depth is deep is produced in reforming.

On the other hand, the case where the rate at breakage exceeds 26 m/min causes drawdown in sheet forming and provides a risk of being liable to cause molding defects.

The inclusion of HMS-PP satisfying the above-mentioned condition (1) allows easily forming a large number of fine closed cells when a polypropylene-based resin composition is extrusion foamed.

The adoption of a polypropylene-based resin in which a free-terminal long chain branching is formed by chemical cross-linking as described above, and which satisfies the above-mentioned condition (1) further allows easily forming a resin foam sheet which has been foamed at an expansion ratio as high as 10 or more times, for example.

In order to produce a foam sheet using such a polypropylene-based resin, the polypropylene-based resin composition may be extrusion foamed after components for foaming, for example, a gas component to be a gaseous condition at least at the melting point of a base polymer, a nucleating agent to form nuclei when the gas bubbles are formed by the gas component, and a thermodecomposable foaming agent generating gas due to the occurrence of thermolysis at least at the melting point of a base polymer, are contained in the polypropylene-based resin composition.

Examples of the gas component include: aliphatic hydrocarbons such as propane, butane and pentane; nitrogen; carbon dioxide; argon; and water.

These gas components may be used each alone or in combinations of two or more thereof.

Examples of the nucleating agent include: particles of inorganic compounds such as talc, mica, silica, diatom earth, aluminum oxide, titanium oxide, zinc oxide, magnesium oxide, magnesium hydroxide, aluminum hydroxide, calcium hydroxide, potassium carbonate, calcium carbonate, magnesium carbonate, potassium sulfate, barium sulfate and glass beads; and particles of organic compounds such as polytetrafluoroethylene.

The nucleating agent can be contained in the material for forming a foam sheet, for example, on the basis of a master batch method in which the nucleating agent is contained in advance in a polyolefin resin; the use of a master batch prepared by dispersing the nucleating agent in a polyolefinic resin so as to have any falling within a range of 5% by mass or more and 50% by mass or less can more effectively use the nucleating agent.

Moreover, examples of the thermodecomposable foaming agent include azodicarbonamide, sodium hydrogen carbonate, and a mixture of sodium hydrogen carbonate and citric acid.

The thermodecomposable foaming agent can be used more effectively by converting the thermodecomposable forming agent into a master batch prepared by dispersing the foaming agent in a polyolefinic resin so as to have any content falling within a range of 10% by mass or more and 50% by mass or less.

In addition to the above, for example, various types of stabilizers such as weatherproof agents, antioxidants and antiaging agents, processing aids such as external lubricants and internal lubricants, and additive agents such as antistatic agents, slip agents, pigments and fillers may be contained in a polypropylene-based resin composition.

Methods for producing the foam sheet according to the present embodiment using such forming materials include ones in which extrusion foaming is carried out using an extruder common as a production facility for foam sheets.

The methods adoptable are, for example, a method in which: polymer components including a polypropylene-based resin component are introduced to an extruder on the upstream side of a tandem extruder; in the extruder, for example, the polymer components are melt-kneaded under a temperature condition advantageous for dissolution of the above-mentioned gas components, and thereafter, for example, the gas component such as butane is injected to a midway portion of the extruder; the resin composition containing the gas component is further kneaded, and extrusion foamed from a flat die or a circular die of an extruder on the downstream side of the tandem extruder under the regulation of the temperature condition suitable for extrusion, to thereby produce a foam sheet.

In the present embodiment, the inclusion of a high melt tension polypropylene resin satisfying the above-mentioned condition (1) in a polypropylene-based resin composition allows securing a broad condition setting range necessary for extrusion foaming a foam sheet having a high expansion ratio and a low open cell ratio, and stably providing good products even if various conditions are altered in a method for producing the foam sheet.

Therefore, a resin foam sheet having a high expansion ratio and a good appearance can easily be produced.

Since a resin foam sheet thus obtained has fine gas bubbles and a high expansion ratio and simultaneously has excellent reformability, the resin foam sheet can easily be processed to containers such as trays by adopting a sheet forming method, for example, vacuum forming, pressure forming, vacuum and pressure forming or press molding.

Furthermore, obtained reformed products have beautiful appearance and a light weight and yet an excellent strength.

In the present embodiment, a foam sheet and a method for producing a foam sheet are exemplified as described above, but in the present invention, a foam sheet and a method for producing a foam sheet are not limited to the above-mentioned exemplifications.

Further in the present embodiment, a foam sheet and a method for producing a foam sheet are exemplified as a resin foam sheet and a method for producing a resin foam sheet, but the present invention is not limited to the foam sheet exemplified above.

For example, the case where a foamed layer is formed by extruding a foam sheet as described above and a non-foamed solid layer is simultaneously coextruded to make a foam sheet of two-layered structure, the case where a foam sheet of three-layered structure having solid layers on both sides is made, and further the case where a foam sheet having four or more-layered laminate structure is made are within the scope of the present invention.

### EXAMPLES

Next, the present invention will be described in more detail with reference to Examples; however the present invention is not limited to these Examples.

### (Production of a Foam Sheet: Production Method 1)

In the production method of a resin foam sheet, extrusion was carried out by preparing a tandem type extruder constituted with a single screw extruder (an upstream side extruder) having a caliber of 90 mm, and another single screw extruder (a downstream side extruder) having a caliber of 115 mm connected to the aforesaid single screw extruder, as a first extruder to melt and mix materials for forming a foaming resin, and connecting a circular die on the downstream side.

To the first-stage hopper of the upstream side single screw extruder having a caliber of 90 mm, a polypropylene-based resin composition composed of the following polymer component and the following foaming agent was fed: a polymer component containing 39% by mass of HMS-PP commercially available from Borealis AG under the trade name “WB135”, 45% by mass of a block PP commercially available from Japan Polypropylene Corp. under the trade name “BC6C”, 6% by mass of a TPO commercially available from SunAllomer Ltd. under the trade name “Q-100F”, and 10% by mass of an ethylene-a-olefin copolymer commercially available from Japan Polyethylene Corp. under the trade name “KS240T” (crystallinity: 26%), and a sodium bicarbonate-citric acid-based foaming agent (trade name: “Finecell Master PO410K,” a master batch manufactured by Dainichiseika Color & Chemicals Mfg. Co., Ltd.) to have a proportion of 0.5 parts by mass in relation to 100 parts by mass of the total amount of the polymer component. The aforementioned polypropylene-based resin composition was heated for melting at a temperature of 200° C. to 210° C. Then, butane (isobutane/normal butane=35% by mass/65% by mass) as a gas component was introduced under pressure into the extruder concerned and kneaded so as to have a proportion of 4 parts by mass in relation to 100 parts by mass of the resulting molten resin, to thereby produce a foaming resin composition.

The resulting foaming resin composition was fed to the downstream side extruder, the temperature of the foaming resin composition was decreased, and the foaming resin composition was extruded in a cylindrical shape at a resin discharge rate of 135 kg/hr from a circular die (diameter: 140 mm, slit gap: 1.0 mm) connected to the end of the extruder, to thereby form a cylindrical foam body.

The cylindrical foam body produced by extrusion foaming was made to move along the outer circumferential surface of a cooling mandrel of 414 mm in diameter and 500 mm in length and thus expanded in diameter; at the same time, the outer surface of the foam body was cooled by blowing air from an air ring, and the foam body was cut open with cutters at two positions (180 degrees apart from each other) symmetric with respect to the circumferential direction of the mandrel to produce two strip-shaped resin foam sheets.

### (Production of a Foam Sheet: Production Method 2)

In the production method of a resin foam sheet, first, there was prepared a tandem type extruder constituted with a single screw extruder (an upstream side extruder) having a caliber of 90 mm, and another single screw extruder (a downstream side extruder) having a caliber of 115 mm connected to the aforesaid single screw extrude; as a first extruder to melt and mix materials for forming a foaming resin layer.

To the first-stage hopper of the upstream side single screw extruder having a caliber of 90 mm, a polypropylene-based resin composition for forming a foam resin layer composed of the following polymer component and the following foaming agent was fed: a polymer component containing 39% by mass of HMS-PP commercially available from Borealis AG under the trade name “WB135”, 45% by mass of a block PP commercially available from Japan Polypropylene Corp. under the trade name “BC6C”, 6% by mass of a TPO commercially available from SunAllomer Ltd. under the trade name “Q-100F”, and 10% by mass of an ethylene-α-olefin copolymer commercially available from Japan Polyethylene Corp. under the trade name “KS240T” (crystallinity: 26%), and a sodium bicarbonate-citric acid-based foaming agent (trade name: “Finecell Master PO410K,” a master batch manufactured by Dainichiseika Color & Chemicals Mfg. Co., Ltd.) to have a proportion of 0.5 parts by mass in relation to 100 parts by mass of the total amount of the polymer component. The aforementioned polypropylene-based resin composition for forming a foam resin layer was heated for melting at a temperature of 200° C. to 210° C. Then, butane (isobutane/normal butane=35% by mass/65% by mass) as a gas component was introduced under pressure into the extruder concerned and kneaded so as to have a proportion of 4 parts by mass in relation to 100 parts by mass of the resulting molten resin, to thereby produce a foaming resin composition.

The foaming resin composition was fed to the downstream side extruder, the temperature of the foaming resin composition was decreased, and the foaming resin composition was extruded at a discharge rate of 120 kg/hr and fed to a confluent mold connected to the end of the extruder concerned.

A single screw extruder having a caliber of 65 mm was prepared as a second extruder connected to the confluent mold; and materials for forming a surface layer (non-foam layer) were melted and mixed.

That is, to the hopper of the second extruder, a polypropylene-based resin composition for forming a surface layer composed of the following polymer component and the following nonionic antistatic agent was fed and heated for melting at a temperature of 200° C.: a polymer component containing 70% by mass of HMS-PP commercially available from Borealis AG under the trade name “WB135” and 30% by mass of an ethylene-a-olefin copolymer commercially available from Japan Polyethylene Corp. under the trade name “KS240T” (crystallinity: 26%), and a nonionic antistatic agent (trade name “TS-2B,” manufactured by Kao Corp.) to have a proportion of 2.0 parts by mass in relation to 100 parts by mass of the total amount of the polymer component.

Next, the (non-foaming) polypropylene-based resin composition in a molten state was divided with a distribution pipe having branched paths, and then the two divided flows of the resin composition were discharged respectively from a central portion and an outer side portion of the resin flow path of the confluent mold, with a total flow rate of the respective flows to be 15 kg/hr; the two divided flows of the resin were merged respectively on the inner layer side and the outer layer side of the foaming resin composition so as to be laminated with each other; thus, the laminated resin compositions were co-extruded in a cylindrical shape at a resin discharge rate of 135 kg/hr from a circular die (diameter: 140 mm, slit gap: 1.0 mm) connected to the end of the confluent mold, to form a cylindrical foam body in which non-foam surface layers were laminated on both of the inner and outer sides of the foamed resin layer through the intermediary of the foamed resin layer.

The cylindrical foam body produced by extrusion foaming was made to move along the outer circumferential surface of a cooling mandrel of 414 mm in diameter and 500 mm in length and thus expanded in diameter; at the same time, the outer surface of the foam body was cooled by blowing air from an air ring, and was cut open with cutters at two positions (180 degrees apart from each other) symmetric with respect to the circumferential direction of the mandrel to produce two strip-shaped resin foam sheets.

### EXAMPLES AND COMPARATIVE EXAMPLES

The melt tensions and the rates at breakage of the virgin material of the above-mentioned HMS-PP (trade name “WB135”), and the HMS-PP after being passed through the extruder (the Labo Plastomill/twin screw extruder described before) were measured using a capillary rheometer.

The measurement was carried out for different production lots of the HMS-PP (trade name “WB135”), and 8 lots therein exhibiting a melt tension after the lot was passed through the extruder of 4 cN or more and 10 cN or less, and a rate at breakage after the lot was passed through the extruder of 12 m/min or higher and 26 m/min or lower were used to produce foam sheets in Examples 1 to 8.

5 Lots thereof out of the above-mentioned requirements were used to produce foam sheets in Comparative Examples 1 to 5.

### (Evaluations)

With respect to the laminate-type foam sheet of Production Method 2 described above, the sheet appearance was visually observed to evaluate the appearance.

In the evaluation, the case where “irregularities” were observed on the surface was considered “×”, and the case of no irregularities was considered “◯”.

The total value of the gas bubble volume and the resin volume was determined using an air pycnometer (air comparison pycnometer), model: 930, made by Beckman Coulter, Inc., and a ratio of a value derived by subtracting the total value from an apparent volume to the apparent volume was expressed in percentage and defined as an open cell ratio.

“Formability” was evaluated by introducing a foam sheet to a single forming machine (unique automatic forming machine, Tousei Sangyo KK), and molding the foam sheet in a forming mold in which protrusions having different heights are installed, when the surface temperature of the foam sheet became 160° C.

Specifically, drawing was carried out using a mold in which truncated quadrangular pyramids (top surface circumference was worked into R0.5 of curved surface) having a bottom surface area of about 500 mm² and a draft of 5 degrees and having heights of five kinds of A to E (in height, A: 27.8 mm, B: 33.4 mm, C: 39.0 mm, D: 44.6 mm, and E: 50.1 mm) were arranged with slight gaps, and the case where no tear occurred for all of the protrusions of A to E was considered “◯”, and the case where tear occurred for any of A to E was considered “×”.

These results are shown in Table 1.

TABLE 1

| | | | After Passed | | | | |
|---|---|---|---|---|---|---|---|
| | Virgin | | Through an | | | | |
| | Material | | Extruder | | | | |
| | | Take-up | | Take-up | | | |
| | | Rate at | Melt | Rate at | | | Open |
| | Melt | Break- | Ten- | Break- | Ap- | | Cell |
| | Tension | age | sion | age | pear- | Forma- | Ratio |
| | (cN) | (m/min) | (cN) | (m/min) | ance | bility | (%) |
| Example 1 | 20.7 | 3.0 | 4.8 | 25.4 | ◯ | ◯ | 11.0 |
| Example 2 | 18.8 | 3.2 | 5.6 | 12.7 | ◯ | ◯ | 9.5 |
| Example 3 | 19.4 | 3.1 | 4.9 | 12.4 | ◯ | ◯ | 10.2 |
| Example 4 | 17.2 | 2.9 | 4.8 | 18.2 | ◯ | ◯ | 9.8 |
| Example 5 | 15.5 | 2.8 | 9.1 | 13 | ◯ | ◯ | 9.8 |
| Example 6 | 22.1 | 2.7 | 8.9 | 25.5 | ◯ | ◯ | 10.2 |
| Example 7 | 21.8 | 2.7 | 4.5 | 23.7 | ◯ | ◯ | 10.3 |
| Example 8 | 22.2 | 2.8 | 5.5 | 9.4 | ◯ | ◯ | 12.5 |
| Comparative | 23.5 | 2.8 | 3.2 | 26.3 | X | X | 14.5 |
| Example 1 | | | | | | | |
| Comparative | 17.3 | 2.4 | 5.5 | 10.6 | X | X | 13.5 |
| Example 2 | | | | | | | |
| Comparative | 18.1 | 3.0 | 3.5 | 13.9 | X | X | 15.2 |
| Example 3 | | | | | | | |
| Comparative | 17.5 | 2.7 | 14.2 | 11.3 | X | X | 13.2 |
| Example 4 | | | | | | | |
| Comparative | 21.7 | 2.9 | 11.3 | 24.5 | X | ◯ | 9.2 |
| Example 5 | | | | | | | |

Lots of “WB135” used were changed; and foam sheets were similarly produced by the method of Production Method 1, and similarly evaluated; but the results were the same as those shown in Table 1.

More specifically, it was confirmed that the foam sheets produced based on “Production Method 1” by utilizing “WB135” satisfying the above-mentioned requirements in the “melt tension” and the “rate at breakage” after being passed through an extruder had good appearance and passed the above-mentioned “◯” and “×” determination for the “formability”, and had low “open cell ratios”.

Also from the above, it is clear that the present invention can provide a resin foam sheet having good reformability.

1. A resin foam sheet, being formed by extrusion foaming with an extruder a polypropylene-based resin composition mainly composed of a polypropylene-based resin component comprising a high melt tension polypropylene resin,
wherein the high melt tension polypropylene resin has a melt tension after being passed through the extruder of 4 cN or more and 10 cN or less, and a rate at breakage after being passed through the extruder of 12 m/min or higher and 26 m/min or lower.

2. The resin foam sheet according to claim 1, wherein the high melt tension polypropylene resin has a free-terminal long chain branching formed by chemical cross-linking.

3. A method for producing a resin foam sheet, comprising extrusion foaming with an extruder a polypropylene-based resin composition mainly composed of a polypropylene-based resin component comprising a high melt tension polypropylene resin, to thereby produce the resin foam sheet,
wherein as the high melt tension polypropylene resin the method uses a high melt tension polypropylene resin having a melt tension after being passed through the extruder of 4 cN or more and 10 cN or less, and a rate at breakage after being passed through the extruder of 12 m/min or higher and 26 m/min or lower.

4. The method for producing a resin foam sheet according to claim 3, wherein the high melt tension polypropylene resin has a free-terminal long chain branching formed by chemical cross-linking.
